(19) United States
(12) Patent Application Publication
(10) Pub. No.: US 2006/0078217 A1
(43) Pub. Date: Apr. 13, 2006

(54) Out-of-focus detection method and imaging device control method

(75) Inventors: Eunice Poon, Ontario (CA); Megumi Kanda, Tokyo (JP); Ian Clarke, Ontario (CA)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/132,449

(22) Filed: May 19, 2005

(30) Foreign Application Priority Data
May 20, 2004 (JP) JP2004-150398
May 21, 2004 (JP) JP2004-152330

(51) Int. Cl. G06K 9/40

(52) U.S. Cl. 382/255

(57) ABSTRACT

The technique of the invention calculates an edge gradient magnitude a(x,y) at each pixel position (x,y) and an edge width w(x,y) from luminance values of an object image, and computes an out-of-focus evaluation value M(x,y) at each pixel position (x,y) from the calculated edge gradient magnitude a(x,y) and edge width w(x,y). The technique then divides the object image into a preset number of blocks, determines a representative out-of-focus evaluation value Y(m,n) in each block, and compares the representative out-of-focus evaluation value Y(m,n) with a preset threshold value for block classification to categorize each block as an in-focus block or an out-of-focus block. The technique eventually determines the object image as in-focus or out-of-focus, based on the total number of blocks included in in-focus block areas, the total number of blocks included in out-of-focus block areas, and the relative positions of the in-focus block areas and the out-of-focus block areas to the whole image.

### BACKGROUND OF THE INVENTION

1. Field of the Invention

The present invention relates to an out-of-focus detection method, an imaging device, and a control method of the imaging device. More specifically the invention pertains to an out-of-focus detection method that detects an out-of-focus image, an imaging device having the function of out-of-focus detection, and a control method of such an imaging device.

2. Description of the Prior Art

One proposed out-of-focus detection method detects an edge of an object to focus a camera on the object (see, for example, Du-Ming Tsai, Hu-Jong Wang, ‘Segmenting Focused Objects in Complex Visual Images’, Pattern Recognition Letters, 1998, 19: 929-940). A known imaging device with the function of out-of-focus detection is, for example, a digital camera that displays a taken object image on a liquid crystal monitor (see, for example, Japanese Patent Laid-OpenGazette No. 2000-209467) This proposed imaging device instantly displays the taken object image on the liquid crystal monitor and enables the user to check the object image.

### SUMMARY OF THE INVENTION

The prior art out-of-focus detect ion method, however, has relatively poor accuracy of out-of-focus detection under some conditions, for example, in the presence of significant noise in the object image or in the lower contrast in a focused area.

The prior art imaging device may take an out-of-focus image of the object, due to the poor technique of the user or the image taking environment. The size and the performance of the liquid crystal monitor often make it difficult for the user to accurately determine whether the object image displayed on the liquid crystal monitor is in focus or out of focus. The user may thus terminate shooting although the taken object image is out of focus.

The out-of-focus detection method of the invention thus aims to adequately detect an out-of-focus image. The out-of-focus detection method of the invention also aims to reduce the processing load required for the out-of-focus detection.

The imaging device and its control method of the invention aim to adequately inform the user of an out-of-focus image. The imaging device and its control method of the invention also aim to adequately detect an out-of-focus image.

In order to attain at least part of the above and the other related objects, the out-of-focus detection method, the imaging device, and its control method of the invention have configurations discussed below.

The present invention is directed to a first out-of-focus detection method that detects an out-of-focus image and includes the steps of: (a) computing an edge evaluation value, which represents an edge level at each of multiple evaluation positions included in an object image, from luminance information with regard to each of pixels constituting the object image; (b) dividing the object image into multiple blocks, where each block includes at least one of the multiple evaluation positions, and determining whether each block is an in-focus block, based on edge evaluation values at respective evaluation positions included in the block; and (c) evaluating the object image as out-of-focus or in-focus, based on a rate of an in-focus area consisting of in-focus blocks determined in the step (b) to the whole object image.

The first out-of-focus detection method computes an edge evaluation value, which represents an edge level at each of multiple evaluation positions included in an object image, from luminance information with regard to each of pixels constituting the object image, and divides the object image into multiple blocks. The first out-of-focus detection method then determines whether each block is an in-focus block, based on edge evaluation values at respective evaluation positions included in the block, and evaluates the object image as out-of-focus or in-focus, based on rates of an in-focus area consisting of determined in-focus blocks to the whole object image. The first out-of-focus detection method specifies the in-focus area and the out-of-focus area according to the edge level and evaluates the object image as out-of-focus or in-focus, based on the rates of the in-focus area to the whole object image. This arrangement ensures adequate detection of an out-of-focus image. The method divides the object image into multiple blocks and executes the subsequent processing including specification of the in-focus area and the out-of-focus area in the units of these divisional blocks. This arrangement desirably reduces the processing load, compared with the prior art processing in the units of pixels.

In the first out-of-focus detection method, a smaller rate of the in-focus area may give a higher potential for evaluating the object image as out-of-focus in the step (c), and the step (c) may evaluate the object image as out-of-focus or in-focus, based on relative positions of the in-focus area to the whole object image.

In one preferable embodiment of the first out-of-focus detection method, the edge evaluation value increases with a decrease in edge level, and a greater edge evaluation value at each evaluation position included in each block gives a lower potential for determining the block as an in-focus block in the step (b). In this embodiment, the step (b) may compute a representative edge evaluation value in each block, based on the edge evaluation values at the respective evaluation positions included in the block, and determine the block as an in-focus block when the representative edge evaluation value in the block is not greater than a preset threshold value, while determining the block not as an in-focus block when the representative edge evaluation value in the block is greater than the preset threshold value.

The step (a) may calculate an edge gradient, which represents a luminance difference between adjoining pixels in either of a horizontal direction and a vertical direction, at each of the multiple evaluation positions in the object image, and compute the edge evaluation value that decreases with an increase in calculated edge gradient. The step (a) may also apply a Sobel edge detection filter to calculate the edge gradient. Further, the step (a) may calculate an edge direction representing a direction of an edge from edge gradients in both a horizontal direction and a vertical direction at each of the multiple evaluation positions in the object image, compute an edge width representing a distance between a pixel with a maximal luminance value and a pixel with a minimal luminance value among adjacent pixels adjoining to each evaluation position in the calculated edge direction, and compute the edge evaluation value that increases with an increase in computed edge width.

The first out-of-focus detection method may further include an additional step (d) executed after the step (b), and the step (d) modify a result of the determination in the step (b) to make a continuous area of blocks of an identical result of block determination.

The present invention is also directed to a second out-of-focus detection method that detects an out-of-focus image and includes the steps of: (a) computing an edge evaluation value, which represents an edge level at each of multiple evaluation positions included in an object image, from luminance information with regard to each of pixels constituting the object image; (b) dividing the object image into multiple blocks, where each block includes at least one of the multiple evaluation positions, and determining whether each block is an out-of-focus block, based on edge evaluation values at respective evaluation positions included in the block; and (c) evaluating the object image as out-of-focus or in-focus, based on a rate of an out-of-focus area consisting of out-of-focus blocks determined in the step (b) to the whole object image.

The second out-of-focus detection method computes an edge evaluation value, which represents an edge level at each of multiple evaluation positions included in an object image, from luminance information with regard to each of pixels constituting the object image, and divides the object image into multiple blocks. The second out-of-focus detection method then determines whether each block is an out-of-focus block, based on edge evaluation values at respective evaluation positions included in the block, and evaluates the object image as out-of-focus or in-focus, based on rates of an out-of-focus area consisting of determined out-of-focus blocks to the whole object image. The second out-of-focus detection method specifies the in-focus area and the out-of-focus area according to the edge level and evaluates the object image as out-of-focus or in-focus, based on the rates of the out-of-focus area to the whole object image. This arrangement ensures adequate detection of an out-of-focus image. The method divides the object image into multiple blocks and executes the subsequent processing including specification of the in-focus area and the out-of-focus area in the units of these divisional blocks. This arrangement desirably reduces the processing load, compared with the prior art processing in the units of pixels.

In the second out-of-focus detection method, a greater rate of the out-of-focus area may give a higher potential for evaluating the object image as out-of-focus in the step (c), and the step (c) may evaluate the object image as out-of-focus or in-focus, based on relative positions of the out-of-focus area to the whole object image.

In one preferable embodiment of the second out-of-focus detection method, the edge evaluation value increases with a decrease in edge level, and a greater edge evaluation value at each evaluation position included in each block gives a higher potential for determining the block as an out-of-focus block in the step (b). In this embodiment, the step (b) may compute a representative edge evaluation value in each block, based on the edge evaluation values at the respective evaluation positions included in the block, and determine the block not as an out-of-focus block when the representative edge evaluation value in the block is not greater than a preset threshold value, while determining the block as an out-of-focus block when the representative edge evaluation value in the block is greater than the preset threshold value. The step (a) may calculate an edge gradient, which represents a luminance difference between adjoining pixels in either of a horizontal direction and a vertical direction, at each of the multiple evaluation positions in the object image, and compute the edge evaluation value that decreases with an increase in calculated edge gradient. The step (a) may also apply a Sobel edge detection filter to calculate the edge gradient.

Further, the step (a) may calculate an edge direction representing a direction of an edge from edge gradients in both a horizontal direction and a vertical direction at each of the multiple evaluation positions in the object image, compute an edge width representing a distance between a pixel with a maximal luminance value and a pixel with a minimal luminance value among adjacent pixels adjoining to each evaluation position in the calculated edge direction, and compute the edge evaluation value that increases with an increase in computed edge width.

The second out-of-focus detection method may further include an additional step (d) executed after the step (b), and the step (d) modify a result of the determination in the step (b) to make a continuous area of blocks of an identical result of block determination.

The present invention is further directed to a third out-of-focus detection method that detects an out-of-focus image and includes the steps of: (a) computing an edge evaluation value, which represents an edge level at each of multiple evaluation positions included in an object image, from luminance information with regard to each of pixels constituting the object image; (b) dividing the object image into multiple blocks, where each block includes at least one of the multiple evaluation positions, and categorizing each block as an in-focus block or an out-of-focus block, based on edge evaluation values at respective evaluation positions included in the block; and (c) evaluating the object image as out-of-focus or in-focus, based on rates of an in-focus area consisting of in-focus blocks categorized in the step (b) and of an out-of-focus area consisting of out-of-focus blocks categorized in the step (b) to the whole object image.

The third out-of-focus detection method computes an edge evaluation value, which represents an edge level at each of multiple evaluation positions included in an object image, from luminance information with regard to each of pixels constituting the object image, and divides the object image into multiple blocks. The third out-of-focus detection method then categorizes each block as an in-focus block or an out-of-focus block, based on edge evaluation values at respective evaluation positions included in the block, and evaluates the object image as out-of-focus or in-focus, based on rates of an in-focus area consisting of categorized in-focus blocks and of an out-of-focus area consisting of categorized out-of-focus blocks to the whole object image. The third out-of-focus detection method specifies the in-focus area and the out-of-focus area according to the edge level and evaluates the object image as out-of-focus or in-focus, based on the rates of the in-focus area and the out-of-focus area to the whole object image. This arrangement ensures adequate detection of an out-of-focus image. The method divides the object image into multiple blocks and executes the subsequent processing including specification of the in-focus area and the out-of-focus area in the units of these divisional blocks. This arrangement desirably reduces the processing load, compared with the prior art processing in the units of pixels.

In the third out-of-focus detection method, a smaller rate of the in-focus area and a greater rate of the out-of-focus area may give a higher potential for evaluating the object image as out-of-focus in the step (c). Further, the step (c) may evaluate the object image as out-of-focus or in-focus, based on relative positions of the in-focus area and the out-of-focus area to the whole object image.

In one preferable embodiment of the third out-of-focus detection method of the invention, the edge evaluation value increases with a decrease in edge level, and a greater edge evaluation value at each evaluation position included in each block gives a higher potential for categorizing the block as an out-of-focus block and a lower potential for categorizing the block as an in-focus block in the step (b). In this embodiment, the step (b) may compute a representative edge evaluation value in each block, based on the edge evaluation values at the respective evaluation positions included in the block, and categorize the block as an in-focus block when the representative edge evaluation value in the block is not greater than a preset threshold value, while categorizing the block not as an in-focus block when the representative edge evaluation value in the block is greater than the preset threshold value. Further, the step (b) may compute a representative edge evaluation value in each block, based on the edge evaluation values at the respective evaluation positions included in the block, and categorize the block not as an out-of-focus block when the representative edge evaluation value in the block is not greater than a preset threshold value, while categorizing the block as an out-of-focus block when the representative edge evaluation value in the block is greater than the preset threshold value. The step (a) may calculate an edge gradient, which represents a luminance difference between adjoining pixels in either of a horizontal direction and a vertical direction, at each of the multiple evaluation positions in the object image, and compute the edge evaluation value that decreases with an increase in calculated edge gradient. The step (a) may also apply a Sobel edge detection filter to calculate the edge gradient. Further, the step (a) may calculate an edge direction representing a direction of an edge from edge gradients in both a horizontal direction and a vertical direction at each of the multiple evaluation positions in the object image, compute an edge width representing a distance between a pixel with a maximal luminance value and a pixel with a minimal luminance value among adjacent pixels adjoining to each evaluation position in the calculated edge direction, and compute the edge evaluation value that increases with an increase in computed edge width.

The third out-of-focus detection method may further include an additional step (d) executed after the step (b), and the step (d) modify a result of the categorization in the step (b) to make a continuous area of blocks of an identical result of block categorization.

The present invention is also directed to a fourth out-of-focus detection method that detects an out-of-focus image and includes the steps of: (a) computing an edge evaluation value, which represents an edge level at each of multiple evaluation positions included in an object image, from luminance information with regard to each of pixels constituting the object image; (b) dividing the object image into multiple blocks, where each block includes at least one of the multiple evaluation positions, and determining whether each block is an in-focus block, based on edge evaluation values at respective evaluation positions included in the block; and (c) evaluating the object image as out-of-focus or in-focus, based on a rate of an in-focus area consisting of in-focus blocks determined in the step (b) to the whole object image.

The fourth out-of-focus detection method computes an edge evaluation value, which represents an edge level at each of multiple evaluation positions included in an object image, from luminance information with regard to each of pixels constituting the object image, and divides the object image into multiple blocks. The fourth out-of-focus detection method then determines whether each block is an in-focus block, based on edge evaluation values at respective evaluation positions included in the block, and evaluates the object image as out-of-focus or in-focus, based on rates of an in-focus area consisting of determined in-focus blocks to the whole object image. The fourth out-of-focus detection method specifies the in-focus area and the out-of-focus area according to the edge level and evaluates the object image as out-of-focus or in-focus, based on the rates of the in-focus area to the whole object image. This arrangement ensures adequate detection of an out-of-focus image. The method divides the object image into multiple blocks and executes the subsequent processing including specification of the in-focus area and the out-of-focus area in the units of these divisional blocks. This arrangement desirably reduces the processing load, compared with the prior art processing in the units of pixels.

The present invention is directed to a control method of an imaging device that takes an object image and stores the object image in a storage medium and includes the steps of: (a) evaluating a target area out of multiple divisional areas constituting the object image stored in the storage medium, as out-of-focus or in-focus; and (b) outputting a result of the evaluation in the step (a).

The control method of the invention evaluates the target area out of multiple divisional areas constituting the object image stored in the storage medium, as out-of-focus or in-focus, and outputs a result of the evaluation. The user is thus adequately informed of an out-of-focus image. The output of the evaluation result may be audio output or screen output of the evaluation result.

The control method of the invention may further include the step of: (c) setting the target area in the object image, where the step (a) evaluates the set target area as out-of-focus or in-focus. In this embodiment, the step (c) may divide the object image into a preset number of divisional areas, display an image split screen to be selectable from the preset number of divisional areas, and set a selected divisional area on the displayed image split screen to the target area. Further, the step (c) may set a specific area including a center of the object image to the target area. When the object image includes a person, the step (c) may set a specific area around the person's face to the target area. The step (c) may also set a specific area around an image area of the object image including a preset range of skin color to the target area.

In one preferable embodiment of the control method of the invention, the step (a) computes an edge evaluation value, which represents an edge level at each of multiple evaluation positions included in the target area, from luminance information with regard to each of pixels constituting the target area, divides the target area into multiple blocks, where each block includes at least one of the multiple evaluation positions, determines whether each block is an in-focus block, based on edge evaluation values at respective evaluation positions included in the block, and evaluates the target area as out-of-focus or in-focus, based on a rate of an in-focus area consisting of determined in-focus blocks to the whole target area. Further,

the step (a) may compute an edge evaluation value, which represents an edge level at each of multiple evaluation positions included in the target area, from luminance information with regard to each of pixels constituting the target area, divide the target area into multiple blocks, where each block includes at least one of the multiple evaluation positions, determine whether each block is an out-of-focus block, based on edge evaluation values at respective evaluation positions included in the block, and evaluate the target area as out-of-focus or in-focus, based on a rate of an out-of-focus area consisting of determined out-of-focus blocks to the whole target area. Moreover, the step (a) may compute an edge evaluation value, which represents an edge level at each of multiple evaluation positions included in the target area, from luminance information with regard to each of pixels constituting the target area, divide the target area into multiple blocks, where each block includes at least one of the multiple evaluation positions, categorize each block as an in-focus block or an out-of-focus block, based on edge evaluation values at respective evaluation positions included in the block, and evaluate the target area as out-of-focus or in-focus, based on rates of an in-focus area consisting of categorized in-focus blocks and of an out-of-focus area consisting of categorized out-of-focus blocks to the whole target area.

The present invention is further directed to an imaging device that takes an object image and includes: an image storage module that stores the object image; an out-of-focus detection module that evaluates a target area out of multiple divisional areas constituting the object image stored in the image storage module, as out-of-focus or in-focus; and a detection result output module that outputs a result of the evaluation.

The imaging device of the invention evaluates the target area out of multiple divisional areas constituting the object image stored in the storage medium, as out-of-focus or in-focus, and outputs a result of the evaluation. The user is thus adequately informed of an out-of-focus image. The output of the evaluation result may be audio output or screen output of the evaluation result.

### BRIEF DESCRIPTION OF THE DRAWINGS

FIG. 1 is a flowchart showing a processing routine of out-of-focus detection method in one embodiment of the invention;

FIG. 2 shows a Sobel filter;

FIG. 3 shows edge gradients dx and dy in relation to an edge direction 0;

FIG. 4 shows one example of an edge width w(x,y);

FIG. 5 schematically shows one example of block classification X(m,n);

FIG. 6 shows an object separation process;

FIG. 7 is a perspective view illustrating the appearance of a digital camera in one embodiment of the invention;

FIG. 8 is a rear view illustrating a rear face of the digital camera of the embodiment;

FIG. 9 is a block diagram showing the functional blocks of the digital camera of the embodiment;

FIG. 10 is a flowchart showing an image evaluation routine executed in the embodiment;

FIG. 11 shows an image split screen displayed on a liquid crystal display; and

FIG. 12 shows a message displayed in response to detection of an out-of-focus image.

### DESCRIPTION OF THE PREFERRED EMBODIMENTS

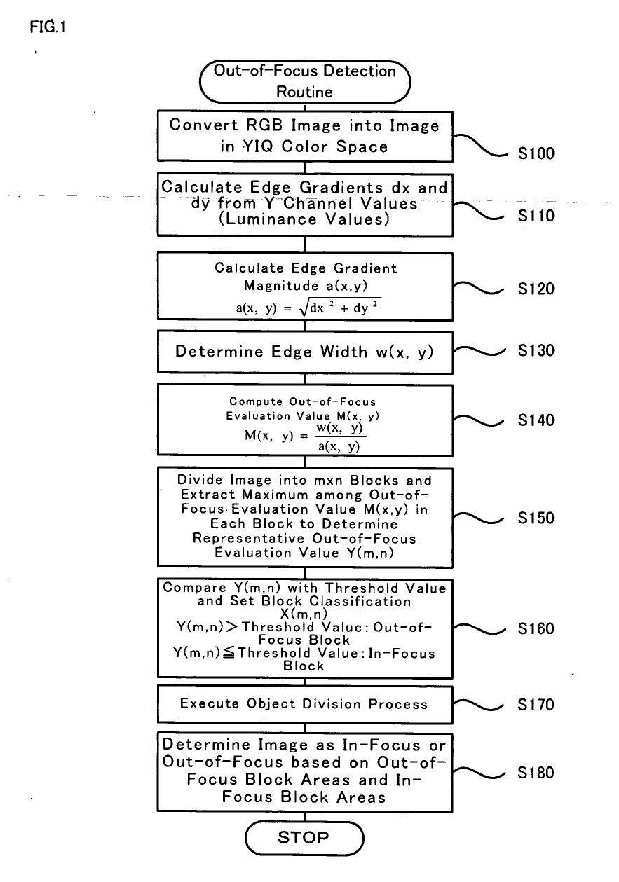

One mode of carrying out the invention is described below as a preferred embodiment. FIG. 1 is a flowchart showing a processing routine of out-of-focus detection method in one embodiment of the invention. The out-of-focus detection routine first converts an RGB image expressed in a color system of red (R), green (G), and blue (B) into a YIQ color space of three primary elements Y (luminance), I (orange-cyan), and Q (green-magenta) according to Equations (1) to (3) given below (step S100):
Y=0.299R+0.587G+0.114B (1)
I=0.596R−0.274G+0.322B (2)
Q=0.211R−0.523G+0.312B (3)

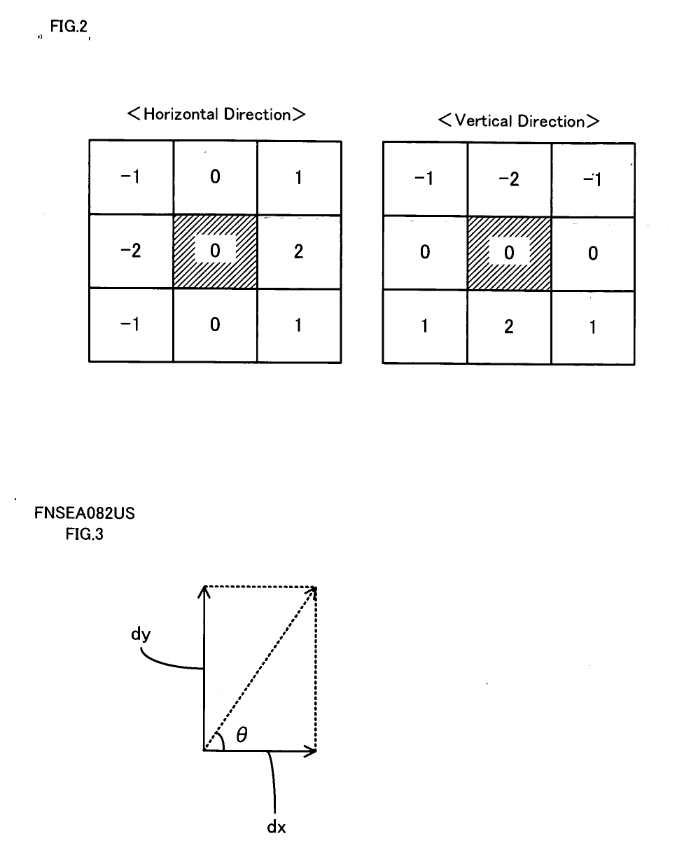

The out-of-focus detection routine then reads the Y channel values (luminance values) of the converted image in the YIQ color space and computes edge gradients dx and dy in both horizontal and vertical directions at each pixel position (x,y) (step S110). The out-of-focus detection routine calculates an edge gradient magnitude a(x,y) from the computed edge gradients dx and dy according to Equation (4) given below (step S120):
a(x,y)=\sqrt{dx²+dy²} (4)
This embodiment adopts a Sobel filter shown in FIG. 2 for computation of the edge gradients dx and dy. The concrete procedure multiplies the luminance values of nine pixels, that is, an object pixel (x,y) and its peripheral pixels located above, below, on the left, the upper left, the lower left, the right, the upper right, and the lower right of the object pixel, by corresponding coefficients in the Sobel filter and sums up the products to obtain the edge gradients dx and dy.

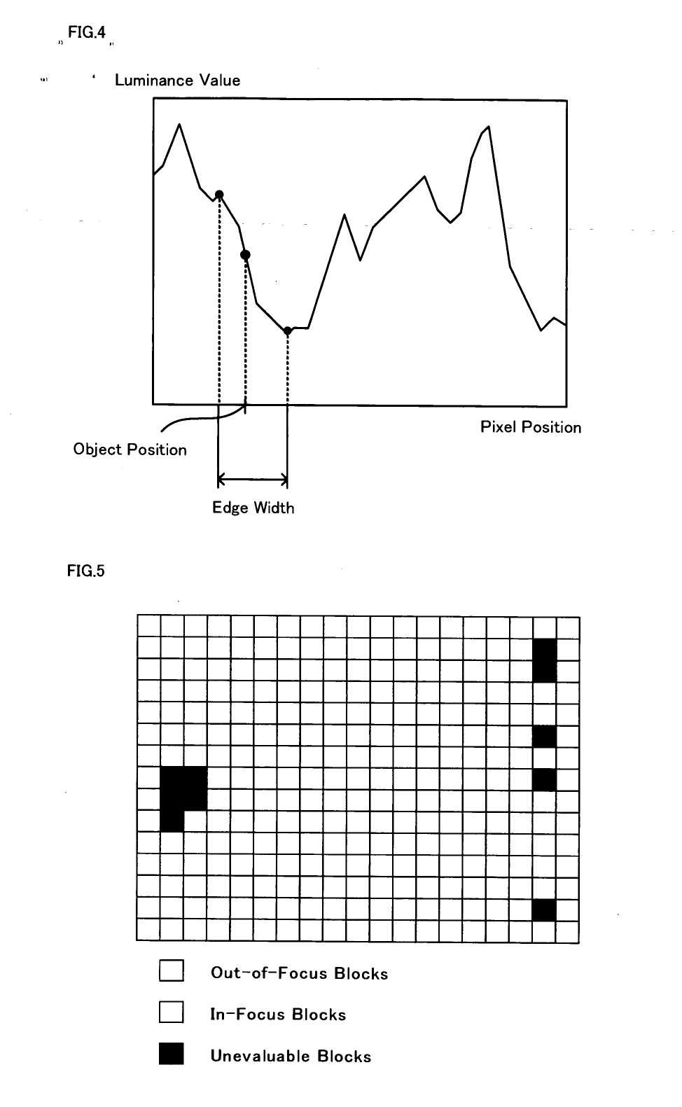

The out-of-focus detection routine subsequently calculates an edge direction θ from the computed edge gradients dx and dy and determines an edge width w(x,y) in a specified direction (either the horizontal direction or the vertical direction) corresponding to the calculated edge direction θ (step S130). FIG. 3 conceptually shows the edge direction θ. As clearly understood from the conceptive view of FIG. 3, the edge direction θ is obtained as a value satisfying Equation (5) representing the relation to the edge gradients dx and dy as given below:
tan θ=dy/dx (5)
The edge direction θ is substantially perpendicular to an edge contour line. FIG. 4 shows one example of the edge width w(x,y). The edge width w(x,y) is a distance (expressed by the number of pixels) between a pixel position of a first maximal luminance value nearest to an object pixel position (x,y) and a pixel position of a first minimal luminance value nearest to the object pixel position (x,y). The direction of the edge width w(x,y) is set to the horizontal direction corresponding to the edge direction θ of less than 45 degrees, while being set to the vertical direction corresponding to the edge direction θ between 45 degrees and 90 degrees.

The out-of-focus detection routine then computes an out-of-focus evaluation value M(x,y) representing the out-of-focus level at each pixel position (x,y) from the calculated edge gradient magnitude a(x,y) and the determined edge width w(x,y) according to Equation (6) given below (step S140):
M(x,y)=w(x,y)/a(x,y) (6)
As clearly understood from Equation (6), the out-of-focus evaluation value M(x,y) decreases with an increase in edge gradient magnitude a(x,y) and with a degrease in edge width w(x,y). Namely the presence of a distinct edge having the greater edge gradient and the shorter edge width gives the smaller out-of-focus evaluation value M(x,y). When the edge gradient magnitude a(x,y) is substantially equal to 0, a value representing unevaluable (for example, * (asterisk)) is set to the out-of-focus evaluation value M(x,y) Such edge gradient magnitudes a(x,y) are found, for example, at pixel positions included in image areas of little luminance variation (for example, a sky image area or a sea image area).

After computation of the out-of-focus evaluation value M(x,y) at each pixel position (x,y), the out-of-focus detection routine divides the image into m×n blocks and extracts the maximum among the computed out-of-focus evaluation values M(x,y) at the respective pixel positions (x,y) in each divisional block, so as to determine a representative out-of-focus evaluation value Y(m,n) in each block (step S150).

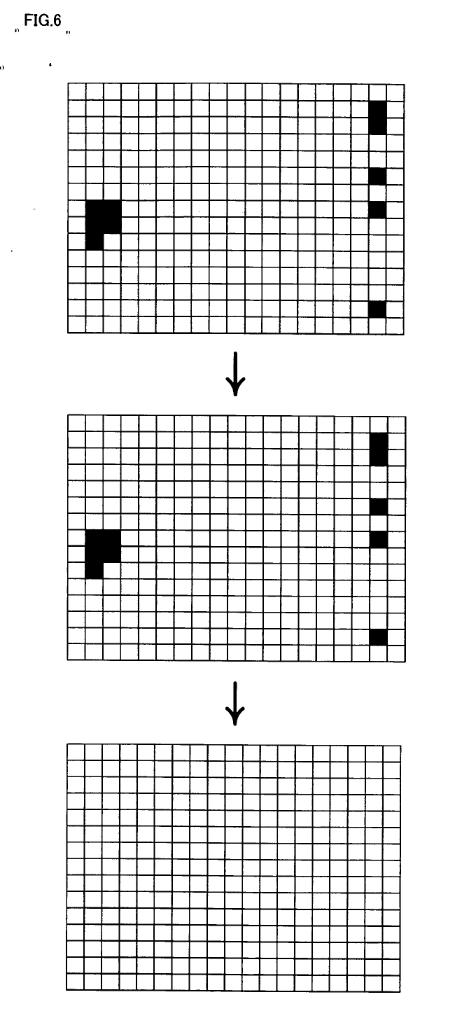

The out-of-focus detection routine then compares the representative out-of-focus evaluation value Y(m,n) in each block with a preset threshold value for block classification, so as to classify the blocks into out-of-focus blocks and in-focus blocks and set block classification X(m,n) (step S160) The block having the representative out-of-focus evaluation value Y(m,n) of greater than the preset threshold value for block classification is categorized as the out-of-focus block. The block having the representative out-of-focus evaluation value Y(m,n) of not greater than the preset threshold value is categorized as the in-focus block. FIG. 5 shows a conceptive image of the settings of block classification X(m,n). As illustrated in FIG. 5, all the blocks are divided into three categories, the out-of-focus blocks, the in-focus blocks, and unevaluable blocks where the out-of-focus evaluation values M(x,y) at all the pixel positions in the block represent unevaluable.

An object division process is then performed on the basis of the settings of block classification X(m,n) and the representative out-of-focus evaluation values Y(m,n) in the respective blocks (step S170). The object division process embeds each isolated in-focus block or each isolated out-of-focus block in adjacent blocks and makes a continuous area of the blocks having an identical setting of block classification X(m,n). The concrete procedure refers to the settings of block classification X(m,n) in adjacent blocks adjoining to each object block, computes posterior probabilities when the object block is assumed as an out-of-focus block and as an in-focus block, and updates the setting of block classification X(m,n) in the object block to the block classification having the higher posterior probability according to Equations (7) through (9) based on the Bayes' theorem as given below:
Prior Probability

$$P ( X ) = {k}_{1} exp \{ {\sum }_{c ∈ C} {f}_{c} ( X ) \} \qquad ( 7 )$$

Likelihood

$$P \text{(} X \vert Y ) = {\prod }_{m , n}^{} {k}_{2} exp \{ - \frac{{( Y ( m , n ) - {μ}_{x ( m , n )} )}^{2}}{2 {σ}_{x ( m , n )}^{2}} \} \qquad ( 8 )$$

Posterior Probability
P(Y|X)=P(X)*P(X|Y) (9)
Here fc(X) is set equal to 0.25 when all adjacent blocks c in a peripheral block set C have an identical setting of block classification X(m,n), while being otherwise set equal to −0.25. In these equations, k1 and k2 are constants, and μ_{x(m,n}, 2σ_{x(m,n)}² respectively represent an average and a square deviation of Y(m,n) having X(m,n).
The object division process repeats the above procedure. FIG. 6 shows a conceptive image of a variation in settings of block classification X(m,n) in the object division process. As illustrated in FIG. 6, the settings of block classification X (m,n) are updated to make a continuous area of the blocks having an identical setting of block classification X(m,n). In the end of the object division process, each unevaluable block is categorizedas either an in-focus block or an out-of-focus block, based on the updated settings of block classification X(m,n) in the adjacent blocks.

On conclusion of the object division process, the image is determined as in-focus or out-of focus, based on the total number of blocks included in in-focus block areas, the total number of blocks included in out-of-focus block areas, and the relative positions of the in-focus block areas and the out-of-focus block areas to the whole image (step S180). Various criteria may be adopted for the determination of whether the image is in-focus or out-of-focus. The procedure of this embodiment determines the image as out-of-focus when the rate of out-of-focus blocks to the whole image (the number of out-of-focus blocks/the total number of blocks in the whole image) is greater than a preset reference value (for example, 0.1) and when the number of sides in contact with the in-focus blocks is not greater than a preset reference number (for example, 2) among the top, bottom, left, and right sides of the image. Adoptable are any other criteria based on the rates of the in-focus block areas and the out-of-focus block areas to the whole image and the relative positions of the in-focus block areas and the out-of-focus block areas. The adopted criterion may be based on only the rates of the in-focus block areas and the out-of-focus block areas to the whole image.

As described above, the out-of-focus detection method of the embodiment calculates the edge gradient magnitude a(x,y) at each pixel position (x,y) and the edge width w(x,y) from the luminance values of an object image, and computes the out-of-focus evaluation value M(x,y) at each pixel position (x,y) from the calculated edge gradient magnitude a(x,y) and the determined edge width w(x,y). The out-of-focus detection method then divides the object image into a preset number of blocks, determines the representative out-of-focus evaluation value Y(m,n) in each block, and compares the representative out-of-focus evaluation value Y(m,n) with the preset threshold value for block classification to categorize each block as an in-focus block or an out-of-focus block. The out-of-focus detection method eventually determines the object image as in-focus or out-of-focus, based on the total number of blocks included in in-focus block areas, the total number of blocks included in out-of-focus block areas, and the relative positions of the in-focus block areas and the out-of-focus block areas to the whole image. The out-of-focus detection method of the embodiment thus ensures adequate detection of the out-of-focus image. The method divides the object image into m×n blocks and executes the subsequent processing in the units of these divisional blocks. This arrangement desirably reduces the processing load, compared with the prior art processing in the units of pixels. The out-of-focus detection method executes the object division process that embeds each isolated in-focus block or each isolated out-of-focus block in adjacent blocks and makes a continuous area of the blocks having an identical setting of block classification X(m,n). This arrangement further enhances the adequacy of detection of the out-of-focus image.

The out-of-focus evaluation value M(x,y) computed in the out-of-focus detection method of the embodiment is equivalent to the edge evaluation value of the invention.

In the out-of-focus detection method of the embodiment, the presence of a distinct edge having the greater edge gradient and the shorter edge width gives the smaller out-of-focus evaluation value M(x,y). One possible modification may set the larger out-of-focus evaluation value in the presence of such a distinct edge. In this modification, the block having the representative out-of-focus evaluation value Y(m,n) of greater than a preset threshold value for block classification is categorized as the in-focus block. The block having the representative out-of-focus evaluation value Y(m,n) of not greater than the preset threshold value is categorized as the out-of-focus block.

The out-of-focus detection method of the embodiment computes the out-of-focus evaluation value M(x,y) at each pixel position (x,y) from the calculated edge gradient magnitude a(x,y) and the determined edge width w(x,y). The out-of-focus evaluation value M(x,y) may be computed from only the edge gradient magnitude a(x,y) or from only the edge width w(x,y). Any other computation technique may be applied to give the out-of-focus evaluation value M(x,y) representing the edge level.

The out-of-focus detection method of the embodiment extracts the maximum among the computed out-of-focus evaluation values M(x,y) at the respective pixel positions (x,y) in each divisional block, so as to determine the representative out-of-focus evaluation value Y(m,n) in each block. The representative out-of-focus evaluation value Y(m,n) in each block may be any other value representing the out-of-focus evaluation values M(x,y) in the block, for example, the total sum, the average, or the median of the out-of-focus evaluations values M(x,y) in the block.

The out-of-focus detection method of the embodiment executes the object division process that embeds each isolated in-focus block or each isolated out-of-focus block in adjacent blocks and makes a continuous area of the blocks having an identical setting of block classification X(m,n). Execution of this object division process is, however, not essential. The modified procedure with omission of the object division process determines the image as in-focus or out-of-focus, based on the settings of block classification X(m,n) obtained at step S160.

The out-of-focus detection method of the embodiment determines the object image as in-focus or out-of-focus, based on the total number of blocks included in in-focus block areas, the total number of blocks included in out-of-focus block areas, and the relative positions of the in-focus block areas and the out-of-focus block areas to the whole image. The determination of the image as in-focus or out-of-focus may be based on the block numbers and the relative positions of only the in-focus block areas or based on the block numbers and the relative positions of only the out-of-focus block areas.

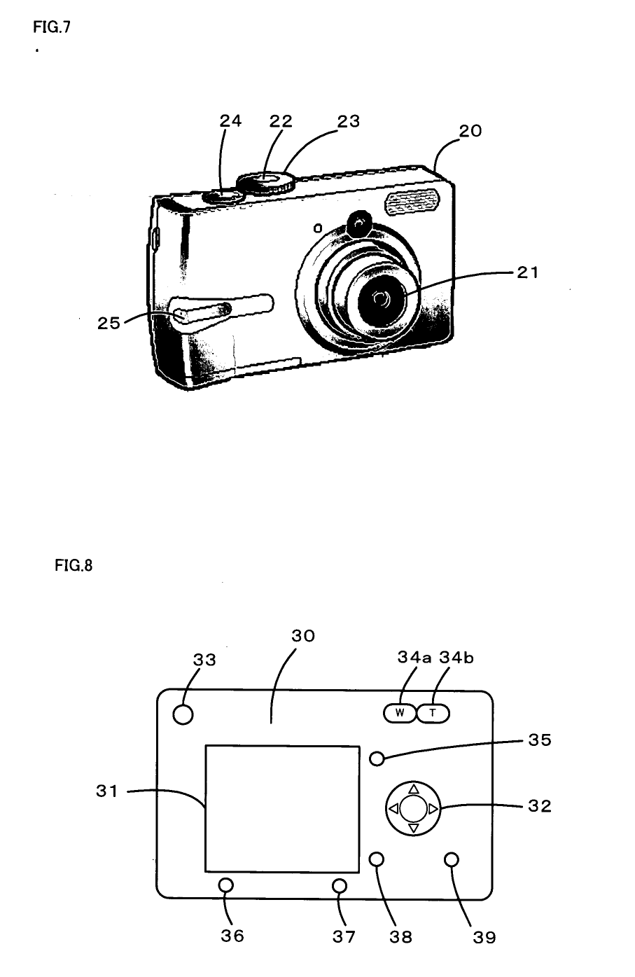

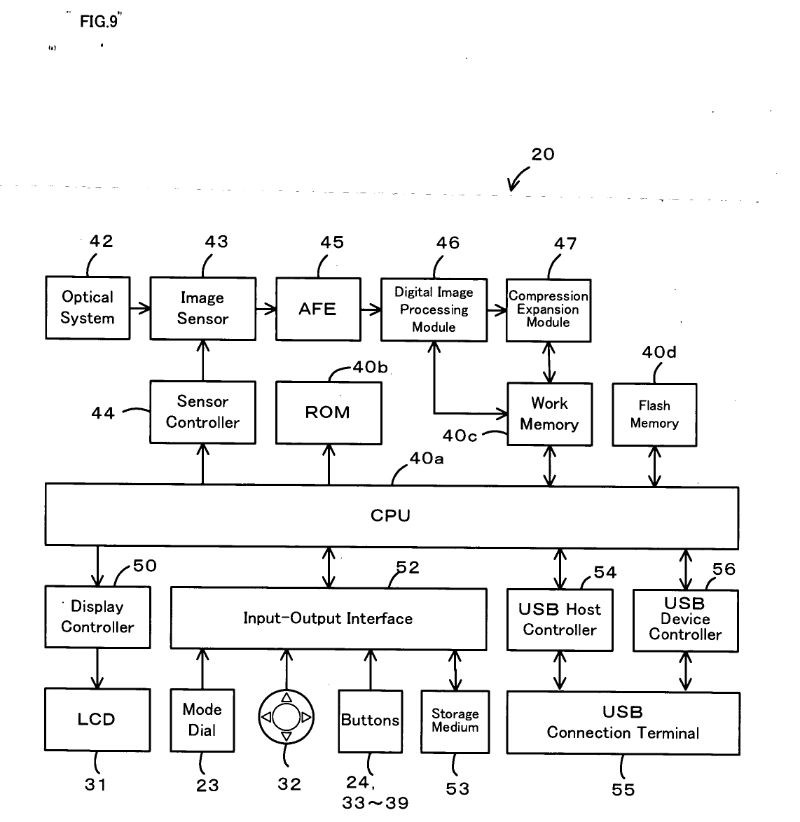

The description below regards the structure of a digital camera 20 as an imaging device in one embodiment of the invention and a control method of the digital camera 20. FIG. 7 is a perspective view illustrating the appearance of the digital camera 20 of the embodiment. FIG. 8 is a rear view illustrating a rear face 30 of the digital camera 20 of the embodiment. FIG. 9 is a block diagram showing the functional blocks of the digital camera 20 of the embodiment.

As illustrated in FIG. 7, a front face of the digital camera 20 of the embodiment has a lens 21 with 3× optical zoom and a self timer lamp 25 that blinks while a self timer is on. A top face of the digital camera 20 has a mode dial 23 for the user's selection of a desired mode, a power button 22 located on the center of the mode dial 23, and a shutter button 24. As illustrated in FIG. 8, the rear face 30 of the digital camera 20 has a liquid crystal display 31 mostly located in the left half, a 4-directional button 32 located on the right of the liquid crystal display 31 to be manipulated by the user in upward, downward, leftward, and rightward directions, a print button 33 located on the upper left corner, and a W button 34a and a T button 34b located on the upper right side for adjustment of the zoom function. The rear face 30 of the digital camera 20 also has a menu button 35 located on the upper left of the 4-directional button 32, an A button 36 and a B button 37 respectively located on the lower left and on the lower right of the liquid crystal display 31, a display button 38 located on the lower left of the 4-directional button 32 for switchover of the display on the liquid crystal display 31, and a review button 39 located on the right of the display button 38.

The digital camera 20 of the embodiment has a CPU (central processing unit) 40a, a ROM 40b for storage of processing programs, a work memory 40c for temporary storage of data, and a flash memory 40d for involatile storage of settings of data as main functional blocks as shown in FIG. 9. An imaging system of the digital camera 20 has an optical system 42 including the lens and a diaphragm, an image sensor 43, a sensor controller 44, an analog front end (AFE) 45, a digital image processing module 46, and a compression expansion module 47. The image sensor 43 accumulates charges obtained by photoelectric conversion of an optical image focused by the optical system 42 in each light receiving cell for a preset time period and outputs an electrical signal corresponding to the accumulated amount of light received in each light receiving cell. The sensor controller 44 functions as a driving circuit to output driving pulses required for actuation of the image sensor 43. The AFE 45 quantizes the electrical signal output from the image sensor 43 to generate a corresponding digital signal. The digital image processing module 46 makes the digital signal output from the AFE 45 subject to a required series of image processing, for example, image formation, white balance adjustment, γ correction, and color space conversion, and outputs processed digital image data representing the R, G, and B tone values or Y, Cb, Cr tone values of the respective pixels. The compression expansion module 47 performs transform (for example, discrete cosine transform or wavelet transform) and entropy coding (for example, run length encoding or Huffman coding) of the processed digital image data to compress the digital image data, while performing inverse transform and decoding to expand the compressed digital image data. In the digital camera 20 of the embodiment, a display controller 50 includes a frame buffer for storage of data representing one image plane of the liquid crystal display 31, and a display circuit for actuation of the liquid crystal display 31 to display a digital image expressed by the data stored in the frame buffer. An input-output interface 52 takes charge of inputs from the mode dial 23, the 4-directional button 32, and the other buttons 24 and 33 to 39, as well as inputs from and outputs to a storage medium 53, for example, a detachable flash memory. The digital camera 20 of the embodiment also has a USB host controller 54 and a USB (Universal Serial Bus) device controller 56 to control communication with a device (for example, a computer or a printer) connected to a USB connection terminal 55. The digital image data processed by the digital image processing module 46 or the digital image data compressed or expanded by the compression expansion module 47 is temporarily stored in the work memory 40c and is written in the storage medium 53 via the input-output interface 52 in the form of an image file with a file name as an ID allocated to the image data in an imaging sequence.

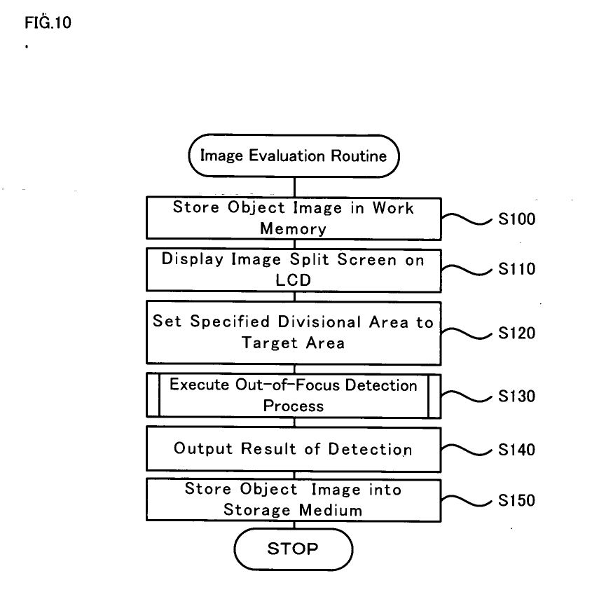

The following description regards the operations of the digital camera 20 of the embodiment configured as discussed above, especially a series of processing to detect an out-of-focus image. FIG. 10 is a flowchart showing an image evaluation routine executed by the CPU 40a at the image taking time. In the image evaluation routine, the CPU 40a first stores image data of an object image taken with the digital camera 20 in the work memory 40c (step S200) and displays an image split screen to show the image split in 9 divisional areas on the liquid crystal display 31 (step S210). FIG. 11 shows one example of the image split screen displayed on the liquid crystal display 31. The image split screen has border lines (broken lines) drawn over the object image for split of the object image into 9 divisional areas. The image split screen is displayed by outputting the object image data stored in the work memory 40c and image data of the border lines stored in advance in the ROM 40b to the liquid crystal display 31 via the display controller 50.

The user manipulates the 4-directional button 32 on the image split screen displayed on the liquid crystal display 31 to move the cursor to a desired divisional area. In response to the user's press of the A button 36, the CPU 40a sets the divisional area with the cursor to a target area (step S220). The CPU 40a then executes an out-of-focus detection process to determine the target area as in-focus or out-of-focus (step S230). The out-of-focus detection process follows the out-of-focus detection routine described above in detail with reference to the flowchart of FIG. 7.

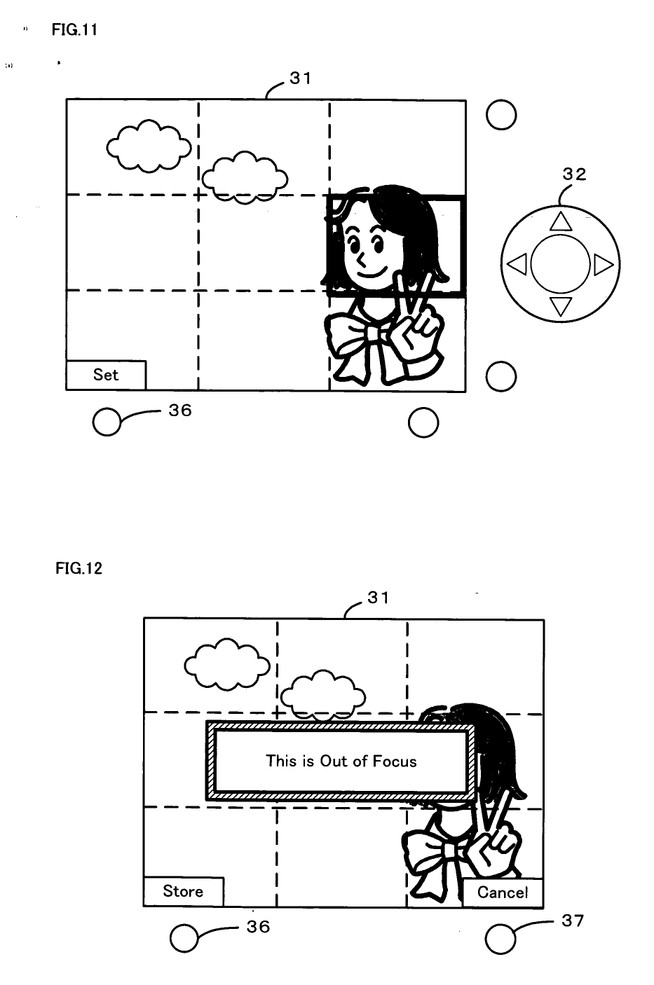

The CPU 40a outputs the result of the out-of-focus detection process with regard to the target area (step S240) In response to judgment of the target area as out-of-focus, the CPU 40a displays a message representing the out-of-focus evaluation on the liquid crystal display 31, simultaneously with sounding an alarm. In response to judgment of the target area as in-focus, on the other hand, the CPU 40a displays a message representing the in-focus evaluation on the liquid crystal display 31. FIG. 12 shows one example of the message representing the out-of-focus evaluation. In response to the user's press of the A button 36, the image data stored in the work memory 40c is written into the storage medium 53 (step S250) The image evaluation routine terminates without writing the image data into the storage medium 53 in response to the user's press of the B button 37. Namely the user can store or delete the image data according to the result of the out-of-focus detection.

As described above, the digital camera 20 of the embodiment or its control method detects an out-of-focus image by evaluation of the target area selected among the divisional areas of an object image in the image split screen and outputs the result of the out-of-focus detection. The user is thus informed of an out-of-focus image.

The digital camera 20 of the embodiment or its control method calculates the edge gradient magnitude a(x,y) at each pixel position (x,y) and the edge width w(x,y) from the luminance values of an object image, and computes the out-of-focus evaluation value M(x,y) at each pixel position (x,y) from the calculated edge gradient magnitude a(x,y) and the determined edge width w(x,y). The digital camera 20 or its control method then divides a specified target area of the object image into a preset number of blocks, determines the representative out-of-focus evaluation value Y(m,n) in each block, and compares the representative out-of-focus evaluation value Y(m,n) with the preset threshold value for block classification to categorize each block as an in-focus block or an out-of-focus block. The digital camera 20 or its control method eventually determines the target area as in-focus or out-of-focus, based on the total number of blocks included in in-focus block areas, the total number of blocks included in out-of-focus block areas, and the relative positions of the in-focus block areas and the out-of-focus block areas to the whole target area. The digital camera 20 of the embodiment or its control method thus ensures adequate detection of the out-of-focus target area. The digital camera 20 of the embodiment or its control method divides the target area into m×n blocks and executes the subsequent processing in the units of these divisional blocks. This arrangement desirably reduces the processing load, compared with the prior art processing in the units of pixels. The digital camera 20 of the embodiment or its control method executes the object division process that embeds each isolated in-focus block or each isolated out-of-focus block in adjacent blocks and makes a continuous area of the blocks having an identical setting of block classification X(m,n). This arrangement further enhances the adequacy of detection of the out-of-focus target area.

The digital camera 20 of the embodiment or its control method displays the image split in 9 divisional areas on the image split screen to set a desired target area for out-of-focus detection. The split in 9 divisional areas is, however, not essential, and the displayed image may be split in any preset number of divisional areas, for example, in 4 divisional areas or in 16 divisional areas. Another method may be adopted to set a desired target area. The target area may be set by specifying an arbitrary position and an arbitrary size or may be set in advance corresponding to a selected image taking mode, for example, portrait or landscape. The target area may otherwise be fixed to a predetermined area (for example, the whole image area or an area of α% around the center position of the image). When the object image includes a person, the target area may be an area of α% around the person's face or may be an area of a % around an image area of the object image including a specific range of skin color in a certain color space.

The digital camera 20 of the embodiment or its control method determines the specified target image as in-focus or out-of-focus, based on the total number of blocks included in in-focus block areas, the total number of blocks included in out-of-focus block areas, and the relative positions of the in-focus block areas and the out-of-focus block areas to the whole target area. The determination of the target area as in-focus or out-of-focus may be based on the block numbers and the relative positions of only the in-focus block areas or based on the block numbers and the relative positions of only the out-of-focus block areas.

The embodiment and its applications discussed above are to be considered in all aspects as illustrative and not restrictive. There may be many modifications, changes, and alterations without departing from the scope or spirit of the main characteristics of the present invention.

All changes within the meaning and range of equivalency of the claims are intended to be embraced therein. The scope and spirit of the present invention are indicated by the appended claims, rather than by the foregoing description.

The disclosures of Japanese Patent Application No. 2004-150398 filed May 20, 2004 and 2004-152330 filed May 21, 2004 including specification, drawings and claims are incorporated herein by reference in its entirety.

1. An out-of-focus detection method that detects an out-of-focus image, said out-of-focus detection method comprising the steps of:
(a) computing an edge evaluation value, which represents an edge level at each of multiple evaluation positions included in an object image, from luminance information with regard to each of pixels constituting the object image;
(b) dividing the object image into multiple blocks, where each block includes at least one of the multiple evaluation positions, and determining whether each block is an in-focus block, based on edge evaluation values at respective evaluation positions included in the block; and
(c) evaluating the object image as out-of-focus or in-focus, based on a rate of an in-focus area consisting of in-focus blocks determined in said step (b) to the whole object image.

2. An out-of-focus detection method in accordance with claim 1, wherein a smaller rate of the in-focus area give a higher potential for evaluating the object image as out-of-focus in said step (c).

3. An out-of-focus detection method in accordance with claim 1, wherein said step (c) evaluates the object image as out-of-focus or in-focus, based on relative positions of the in-focus area to the whole object image.

4. An out-of-focus detection method in accordance with claim 1, wherein the edge evaluation value increases with a decrease in edge level, and
a greater edge evaluation value at each evaluation position included in each block gives a lower potential for determining the block as an in-focus block in said step (b).

5. An out-of-focus detection method in accordance with claim 4, wherein said step (b) computes a representative edge evaluation value in each block, based on the edge evaluation values at the respective evaluation positions included in the block, and determines the block as an in-focus block when the representative edge evaluation value in the block is not greater than a preset threshold value, while determining the block not as an in-focus block when the representative edge evaluation value in the block is greater than the preset threshold value.

6. An out-of-focus detection method in accordance with claim 4, wherein said step (a) calculates an edge gradient, which represents a luminance difference between adjoining pixels in either of a horizontal direction and a vertical direction, at each of the multiple evaluation positions in the object image, and computes the edge evaluation value that decreases with an increase in calculated edge gradient.

7. An out-of-focus detection method in accordance with claim 6, wherein said step (a) applies a Sobel edge detection filter to calculate the edge gradient.

8. An out-of-focus detection method in accordance with claim 4, wherein said step (a) calculates an edge direction representing a direction of an edge from edge gradients in both a horizontal direction and a vertical direction at each of the multiple evaluation positions in the object image, computes an edge width representing a distance between a pixel with a maximal luminance value and a pixel with a minimal luminance value among adjacent pixels adjoining to each evaluation position in the calculated edge direction, and computes the edge evaluation value that increases with an increase in computed edge width.

9. An out-of-focus detection method in accordance with claim 1, said out-of-focus detection method further comprising an additional step (d) executed after said step (b),
said step (d) modifying a result of the determination in said step (b) to make a continuous area of blocks of an identical result of block determination.

10. An out-of-focus detection method that detects an out-of-focus image, said out-of-focus detection method comprising the steps of:
(a) computing an edge evaluation value, which represents an edge level at each of multiple evaluation positions included in an object image, from luminance information with regard to each of pixels constituting the object image;
(b) dividing the object image into multiple blocks, where each block includes at least one of the multiple evaluation positions, and determining whether each block is an out-of-focus block, based on edge evaluation values at respective evaluation positions included in the block; and
(c) evaluating the object image as out-of-focus or in-focus, based on a rate of an out-of-focus area consisting of out-of-focus blocks determined in said step (b) to the whole object image.

11. An out-of-focus detection method in accordance with claim 10, wherein a greater rate of the out-of-focus area give a higher potential for evaluating the object image as out-of-focus in said step (c).

12. An out-of-focus detection method in accordance with claim 10, wherein said step (c) evaluates the object image as out-of-focus or in-focus, based on relative positions of the out-of-focus area to the whole object image.

13. An out-of-focus detection method in accordance with claim 10, wherein the edge evaluation value increases with a decrease in edge level, and
a greater edge evaluation value at each evaluation position included in each block gives a higher potential for determining the block as an out-of-focus block in said step (b).

14. An out-of-focus detection method in accordance with claim 13, wherein said step (b) computes a representative edge evaluation value in each block, based on the edge evaluation values at the respective evaluation positions included in the block, and determines the block not as an out-of-focus block when the representative edge evaluation value in the block is not greater than a preset threshold value, while determining the block as an out-of-focus block when the representative edge evaluation value in the block is greater than the preset threshold value.

15. An out-of-focus detection method in accordance with claim 13, wherein said step (a) calculates an edge gradient, which represents a luminance difference between adjoining pixels in either of a horizontal direction and a vertical direction, at each of the multiple evaluation positions in the object image, and computes the edge evaluation value that decreases with an increase in calculated edge gradient.

16. An out-of-focus detection method in accordance with claim 15, wherein said step (a) applies a Sobel edge detection filter to calculate the edge gradient.

17. An out-of-focus detection method in accordance with claim 13, wherein said step (a) calculates an edge direction representing a direction of an edge from edge gradients in both a horizontal direction and a vertical direction at each of the multiple evaluation positions in the object image, computes an edge width representing a distance between a pixel with a maximal luminance value and a pixel with a minimal luminance value among adjacent pixels adjoining to each evaluation position in the calculated edge direction, and computes the edge evaluation value that increases with an increase in computed edge width.

18. An out-of-focus detection method in accordance with claim 10, said out-of-focus detection method further comprising an additional step (d) executed after said step (b),
said step (d) modifying a result of the determination in said step (b) to make a continuous area of blocks of an identical result of block determination.

19. An out-of-focus detection method that detects an out-of-focus image, said out-of-focus detection method comprising the steps of:
(a) computing an edge evaluation value, which represents an edge level at each of multiple evaluation positions included in an object image, from luminance information with regard to each of pixels constituting the object image;
(b) dividing the object image into multiple blocks, where each block includes at least one of the multiple evaluation positions, and categorizing each block as an in-focus block or an out-of-focus block, based on edge evaluation values at respective evaluation positions included in the block; and
(c) evaluating the object image as out-of-focus or in-focus, based on rates of an in-focus area consisting of in-focus blocks categorized in said step (b) and of an out-of-focus area consisting of out-of-focus blocks categorized in said step (b) to the whole object image.

20. An out-of-focus detection method in accordance with claim 19, wherein a smaller rate of the in-focus area and a greater rate of the out-of-focus area give a higher potential for evaluating the object image as out-of-focus in said step (c).

21. An out-of-focus detection method in accordance with claim 19, wherein said step (c) evaluates the object image as out-of-focus or in-focus, based on relative positions of the in-focus area and the out-of-focus area to the whole object image.

22. An out-of-focus detection method in accordance with claim 19, wherein the edge evaluation value increases with a decrease in edge level, and
a greater edge evaluation value at each evaluation position included in each block gives a higher potential for categorizing the block as an out-of-focus block and a lower potential for categorizing the block as an in-focus block in said step (b).

23. An out-of-focus detection method in accordance with claim 22, wherein said step (b) computes a representative edge evaluation value in each block, based on the edge evaluation values at the respective evaluation positions included in the block, and categorizes the block as an in-focus block when the representative edge evaluation value in the block is not greater than a preset threshold value, while categorizing the block not as an in-focus block when the representative edge evaluation value in the block is greater than the preset threshold value.

24. An out-of-focus detection method in accordance with claim 22, wherein said step (b) computes a representative edge evaluation value in each block, based on the edge evaluation values at the respective evaluation positions included in the block, and categorizes the block not as an out-of-focus block when the representative edge evaluation value in the block is not greater than a preset threshold value, while categorizing the block as an out-of-focus block when the representative edge evaluation value in the block is greater than the preset threshold value.

25. An out-of-focus detection method in accordance with claim 22, wherein said step (a) calculates an edge gradient, which represents a luminance difference between adjoining pixels in either of a horizontal direction and a vertical direction, at each of the multiple evaluation positions in the object image, and computes the edge evaluation value that decreases with an increase in calculated edge gradient.

26. An out-of-focus detection method in accordance with claim 25, wherein said step (a) applies a Sobel edge detection filter to calculate the edge gradient.

27. An out-of-focus detection method in accordance with claim 22, wherein said step (a) calculates an edge direction representing a direction of an edge from edge gradients in both a horizontal direction and a vertical direction at each of the multiple evaluation positions in the object image, computes an edge width representing a distance between a pixel with a maximal luminance value and a pixel with a minimal luminance value among adjacent pixels adjoining to each evaluation position in the calculated edge direction, and computes the edge evaluation value that increases with an increase in computed edge width.

28. An out-of-focus detection method in accordance with claim 19, said out-of-focus detection method further comprising an additional step (d) executed after said step (b),
said step (d) modifying a result of the categorization in said step (b) to make a continuous area of blocks of an identical result of block categorization.

29. (canceled)

30. A control method of an imaging device that takes an object image and stores the object image in a storage medium, said control method comprising the steps of:
(a) evaluating a target area out of multiple divisional areas constituting the object image stored in the storage medium, as out-of-focus or in-focus; and
(b) outputting a result of the evaluation in said step (a).

31. A control method in accordance with claim 30, said control method further comprising the step of:
(c) setting the target area in the object image,
where said step (a) evaluates the set target area as out-of-focus or in-focus.

32. A control method in accordance with claim 31, wherein said step (c) divides the object image into a preset number of divisional areas, displays an image split screen to be selectable from the preset number of divisional areas, and sets a selected divisional area on the displayed image split screen to the target area.

33. A control method in accordance with claim 31, wherein said step (c) sets a specific area including a center of the object image to the target area.

34. A control method in accordance with claim 31, wherein when the object image includes a person, said step (c) sets a specific area around the person's face to the target area.

35. A control method in accordance with claim 31, wherein said step (c) sets a specific area around an image area of the object image including a preset range of skin color to the target area.

36. A control method in accordance with claim 30, wherein said step (a) computes an edge evaluation value, which represents an edge level at each of multiple evaluation positions included in the target area, from luminance information with regard to each of pixels constituting the target area, divides the target area into multiple blocks, where each block includes at least one of the multiple evaluation positions, determines whether each block is an in-focus block, based on edge evaluation values at respective evaluation positions included in the block, and evaluates the target area as out-of-focus or in-focus, based on a rate of an in-focus area consisting of determined in-focus blocks to the whole target area.

37. A control method in accordance with claim 30, wherein said step (a) computes an edge evaluation value, which represents an edge level at each of multiple evaluation positions included in the target area, from luminance information with regard to each of pixels constituting the target area, divides the target area into multiple blocks, where each block includes at least one of the multiple evaluation positions, determines whether each block is an out-of-focus block, based on edge evaluation values at respective evaluation positions included in the block, and evaluates the target area as out-of-focus or in-focus, based on a rate of an out-of-focus area consisting of determined out-of-focus blocks to the whole target area.

38. A control method in accordance with claim 30, wherein said step (a) computes an edge evaluation value, which represents an edge level at each of multiple evaluation positions included in the target area, from luminance information with regard to each of pixels constituting the target area, divides the target area into multiple blocks, where each block includes at least one of the multiple evaluation positions, categorizes each block as an in-focus block or an out-of-focus block, based on edge evaluation values at respective evaluation positions included in the block, and evaluates the target area as out-of-focus or in-focus, based on rates of an in-focus area consisting of categorized in-focus blocks and of an out-of-focus area consisting of categorized out-of-focus blocks to the whole target area.

39. An imaging device that takes an object image, said imaging device comprising:
an image storage module that stores the object image;
an out-of-focus detection module that evaluates a target area out of multiple divisional areas constituting the object image stored in said image storage module, as out-of-focus or in-focus; and
a detection result output module that outputs a result of the evaluation.
